(19) United States
(12) Patent Application Publication
(10) Pub. No.: US 2002/0090068 A1
(43) Pub. Date: Jul. 11, 2002

(54) Method of transmitting and receiving image files in mobile phone

(75) Inventor: Min-Ho Song, Daegukwangyeok-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 09/928,798

(22) Filed: Aug. 13, 2001

(30) Foreign Application Priority Data
Jan. 11, 2001 (KR) 2001-1611

(51) Int. Cl. H04M 11/00

(52) U.S. Cl. 379/88.13

(57) ABSTRACT

Disclosed is a method of exchanging real images in image files between mobile phones, each having a memory for storing image files. To transmit an image file, a mobile phone receives information about the other party to which an image file selected by the user is to be transmitted and transmits an SMS message having the data of the image file and header information indicating an image message to a mobile phone of the other party by an SMS. To receive an image file, the mobile phone checks header information upon receipt of an SMS message, performs a text message reception operation if the header information of the SMS message indicates a text message, and stores the image file data of the SMS message in the memory if the header information indicates an image message.

### PRIORITY

This application claims priority to an application entitled “Method of Transmitting and Receiving Image File in Mobile Phone” filed in the Korean Industrial Property Office on Jan. 11, 2001 and assigned Serial No. 2001-1611, the contents of which are hereby incorporated by reference.

### BACKGROUND OF THE INVENTION

1. Field of the Invention

The present invention relates generally to a mobile phone, and in particular, to a short message service (SMS).

2. Description of the Related Art

Mobile phone service providers provide information about news, weather, sports, stock quotes, currency rates, traffic state, etc . . . to mobile subscribers by an SMS. The SMS is a bidirectional text service by which short messages are exchanged between mobile phones. A mobile subscriber transmits a text message as short as about 105 bytes, including digits and symbols to another mobile subscriber and receives a message through a PSTN (Public Switched Telephone Network) or the Internet.

Some mobile subscribers transmit text messages representing graphics such as “ˆ _ˆ ” or “:)” using symbols like ˆ , <, >, [,]. However, in order to input graphics in a text message, a mobile subscriber must enter characters or symbols in rows and columns, viewing the display of his mobile phone. Furthermore, the time required to write the text message is long.

To solve the above problems, a method has been suggested in which a mobile subscriber selects a pictorial symbol service menu and transmits a pictorial symbol request message to a hieroglyphics service provider having a variety of pictorial symbols in a database. Then, the service provider searches the database for the requested pictorial symbol and transmits it to the mobile subscriber by the SMS. In this method, pictorial symbols are transmitted easily and rapidly.

As stated above, mobile subscribers can transmit/receive pictorial symbols as well as texts by the SMS, but a pictorial symbol is not an image bit just a symbolical representation of an object achieved by using characters or symbols in combination.

A mobile phone downloads an image file from a PC (Personal Computer) or a web server through the Internet wirelessly. The downloaded image file is used as nothing but a background image for the mobile phone in an idle state.

### SUMMARY OF THE INVENTION

It is, therefore, an object of the present invention to provide a method of transmitting/receiving a real image in an image file between mobile phones.

The above and other objects can be achieved by a method of exchanging real images in image files between mobile phones, each having a memory for storing image files. To transmit an image file, a mobile phone receives information about a mobile phone to be called, to which an image file selected by the user is to be transmitted and transmits an SMS message having the data of the image file and header information indicating an image message to a called mobile phone by an SMS. To receive an image file, the mobile phone checks header information upon receipt of an SMS message, and performs a text message reception operation if the header information of the SMS message indicates a text message, and stores the image file data of the SMS message in the memory if the header information of the SMS message indicates an image message.

### DESCRIPTION OF THE DRAWINGS

The above and other objects, features and advantages of the present invention will become more apparent from the following detailed description when taken in conjunction with the accompanying drawings in which:

FIG. 1 is a block diagram of a mobile phone to which the present invention is applied;

FIG. 2 illustrates the format of an SMS message by which an image message is transmitted according to an embodiment of the present invention;

FIG. 3 is a flowchart illustrating an image message transmitting procedure according to the embodiment of the present invention;

FIGS. 4A to 4G illustrate screen displays produced in the process of image message transmission according to the embodiment of the present invention; and

FIG. 5 is a flowchart illustrating an image message receiving procedure according to the embodiment of the present invention.

### DETAILED DESCRIPTION OF THE PREFERRED EMBODIMENT

A preferred embodiment of the present invention will be described hereinbelow with reference to the accompanying drawings. In the following description, well-known functions or constructions are not described in detail since they would obscure the invention in unnecessary detail.

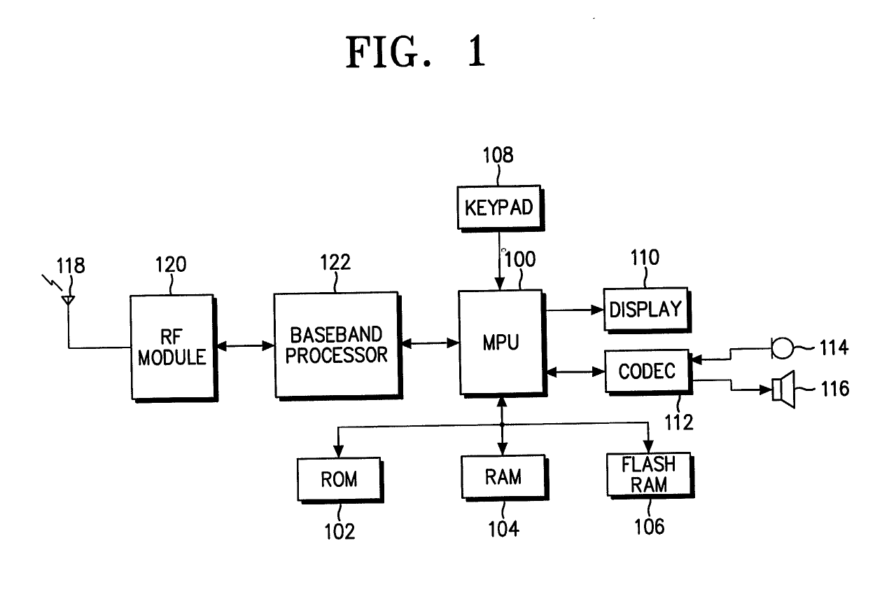

FIG. 1 is a block diagram of a typical mobile phone to which the present invention is applied. Referring to FIG. 1, an MPU (Micro-Processor Unit) 100, according to the present invention, controls transmission/reception of image files as well as telephone calls, data communication, and Internet access. A ROM (Read Only Memory) 102 stores the micro-codes of control programs for the MPU 100 and reference data. A RAM (Random Access Memory) 104 acts as a working memory for the MPU 100. A flash RAM 106 stores updatable data for keeping. The flash RAM 106 is also partially used for storing image file data. A keypad 108 includes a plurality of digit keys and function keys, and provides data corresponding to keys pressed by a user to the MPU 100. A display 110 displays data produced during the control operation of the MPU 100. A CODEC (Coder-Decoder) 112 is connected to the MPU 100. A microphone 114 and a speaker 116 are voice input/output blocks for telephone calls and voice recording. An RF (Radio Frequency) module 120 transmits/receives radio signals to/from a base station (not shown in FIG. 1). The RF module 120 modulates a transmission signal received from the MPU 100 though a baseband processor 122 and transmits the modulated signal through an antenna 118. The RF module 120 demodulates an RF signal received through the antenna 118 and transmits the demodulated signal to the MPU 100. The baseband processor 122 processes baseband signals transmitted between the RF module and the MPU 100.

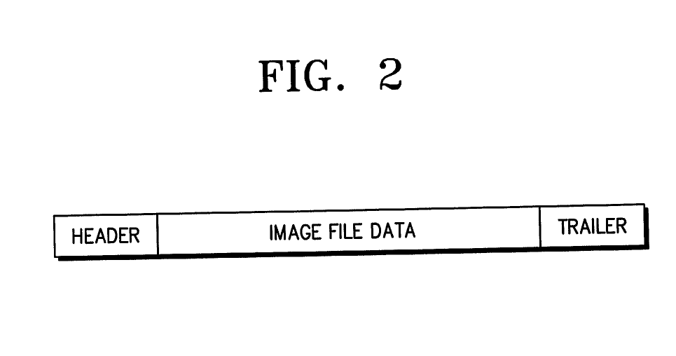

The above mobile phone utilizes the known SMS to transmit/receive an image file in an image message according to the present invention. One thing to note herein is that since the known SMS is limited to transmission of a text message, an SMS message according to the present invention is generated in the format shown in FIG. 2. In FIG. 2, the SMS message is composed of a header indicating the type of the SMS message and a user data field containing image file data. For example, if header information is eight bits,. it is set to “00000000” in the case of a point-to-point text message between mobile phones, to “00000001” in the case of a text message broadcast to mobile phones, and to “00000011” in the case of an image message according to the present invention. Image file data is formed in a graphic format such as a bit map format. When the amount of image file data exceeds the amount of user data transmittable in one SMS message as usual, the image file should be transmitted in a plurality of SMS messages. In the case of an image message, therefore, the SMS message has trailer information after the user data field to indicate whether the image file data continues in the next SMS message or is terminated as shown in FIG. 2. As described above, an image message according to the present invention is transmitted by a known SMS message, which obviates the need for an additional service on behalf of mobile service providers.

Image files to be stored in the flash RAM 106 of FIG. 1 may be downloaded from a PC via a data communication cable provided by a mobile phone manufacturer using a PC-link program as usually done, or from a web site as far as a mobile phone has a wireless Internet access function. As will be described later, the image files can be received from other mobile phones according to the present invention. The mobile phone manufacturer may set the size and number of image files that can be stored in the flash RAM 106. If necessary, a separate memory can be procured to store image files only instead of the flash RAM 106.

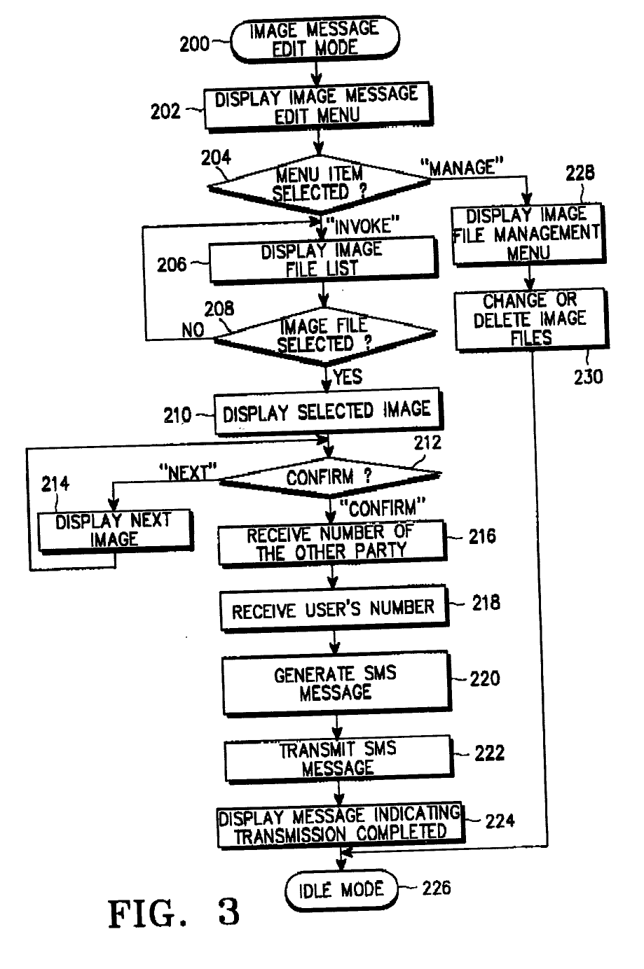

FIG. 3 is a flowchart illustrating an image message transmitting procedure in the MPU 100 according to an embodiment of the present invention. If a user wants to transmit or edit an image message, he selects an image message edit menu that, according to the present invention, is added to usual menus. Then, the MPU 100 enters an image message edit mode in step 200. Aside from menu selection, the image message edit mode can be set by input of a hot key.

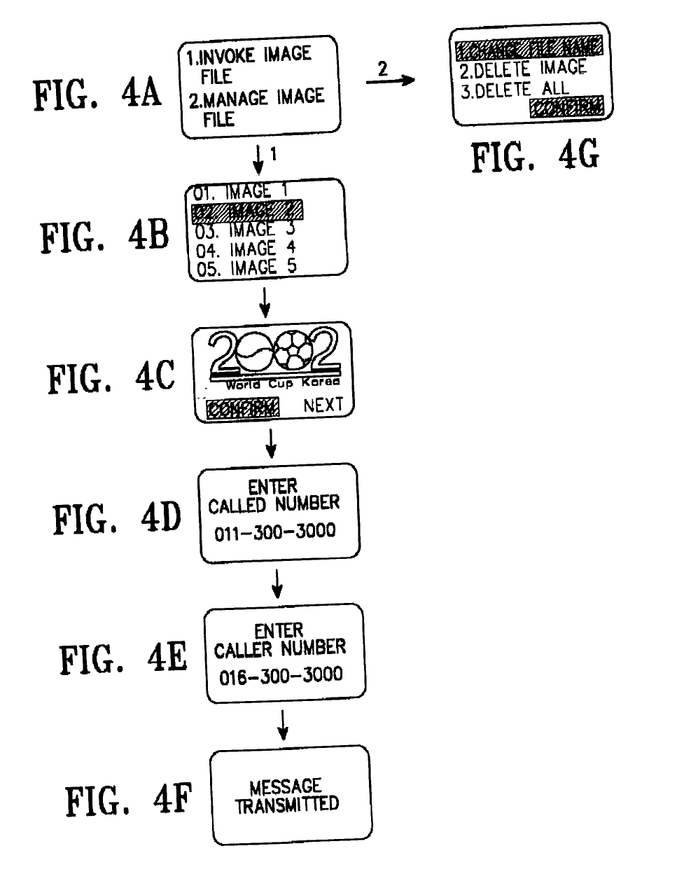

In step 202, the MPU 100 displays an image message edit menu on the display 110 as shown in FIG. 4A. If the user selects “1” through the keypad 108 in the image message edit menu in step 204, the MPU 100 invokes an image file message and if he selects “2”, the MPU 100 performs an image file management operation.

In the former, the MPU 100 displays an image file list stored in the flash RAM 106 as shown in FIG. 4B in step 206 and awaits user selection in step 208. The user places a cursor on an intended image file using a directional key and enters a key designated to confirm in the same manner as selection of a menu item. In step 210, the MPU 100 displays the selected image on the display 110 as shown in FIG. 4C. If the user selects “next” in step 212, the MPU 100 displays the image of the next image file in the image file list in step 214. If the user selects “confirm” in step 212, the MPU 100 displays a message requesting entry of the number to be called and a message requesting entry the caller's number as shown in FIGS. 4D and 4E, and sequentially receives the called number and the calling number as in a conventional text message transmission procedure in steps 216 and 218. The user presses the key after he enters each number. The MPU 100 generates an SMS message in the format shown in FIG. 2 in step 220 and transmits it in step 222. If the data amount of the image file exceeds the user data amount allowed for one SMS message, the image file is transmitted continuously in a plurality of SMS messages with trailer information indicating continuation or termination of the image file. In step 224, the MPU 100 displays a message indicating transmission completion on the display 110 as shown in FIG. 4F and enters an idle mode in step, 226.

On the other hand, if the user selects the image file management menu item in step 204, the MPU 100 displays an image file management menu as shown in FIG. 4G in step 228. The MPU 100 changes the name of an image file or deletes the image file selected by the user, or deletes all image files stored in the flash RAM 106 upon user request in step 230 and enters the idle mode in step 226.

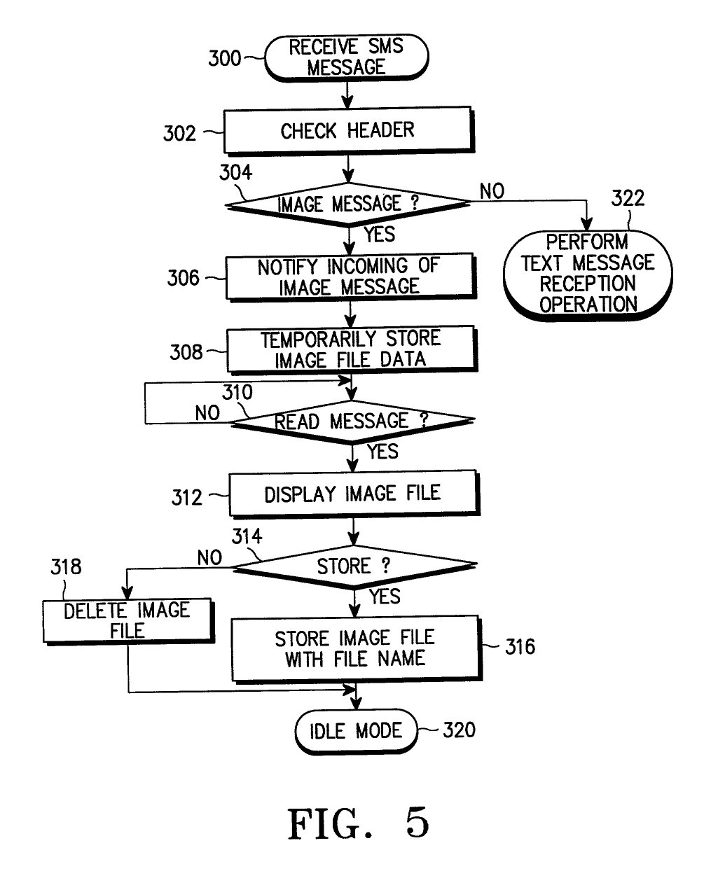

FIG. 5 is a flowchart illustrating an image file receiving procedure in the MPU 100 according to the embodiment of the present invention. Referring to FIG. 5, upon receipt of an SMS message in step 300, the MPU 100 checks the header of the SMS message shown in FIG. 2 in steps 302 and 304. If the header indicates a conventional text message, the MPU 100 performs a typical text message reception operation in step 322. On the other hand, if the header indicates an image message, the MPU 100 alerts the user of an incoming image message by sounding an alarm and displays a predetermined icon on the display 110 in step 306. In step 308, the MPU 100 temporarily stores the image file data of the image message in the flash RAM 106. The MPU 100 checks the trailer information of the image message to determine whether other SMS messages will follow or if the image message is terminated. If there are other SMS messages to come, the MPU 100 receives all image file data by repeating steps 300 to 308.

If the user selects “read message” in step 310, the MPU 100 displays the temporarily stored image file on the display 110 in step 312, stores or deletes the image message upon user request in steps 314 to 318, and enters the idle mode in step 320. If the image file is to be stored, a file name entered by the user is attached to the image file. That is, image files to be stored can be managed in a separate image folder.

In accordance with the present invention as described above, image files are exchanged between mobile phones by the SMS. Therefore, more diverse messages can be transmitted as compared to transmission of characters or pictorial symbols alone while service providers need not provide an additional service, A received image file can be used for a background image or transmitted to another mobile phone again.

While the invention has been shown and described with reference to a certain preferred embodiment thereof, it is a mere exemplary application. The image file transmission function according to the present invention can be utilized effectively for commercial purposes in that it enables transmission of an advertisement image message by the SMS only. Therefore, it will be understood by those skilled in the art that various changes in form and details may be made therein without departing from the spirit and scope of the invention as defined by the appended claims.

What is claimed is:

1. A method of transmitting information by a short message service (SMS) in a mobile phone having a memory for storing image files, comprising the steps of:
receiving information about a mobile phone to be called to which an image file selected by a user is to be transmitted; and
transmitting an SMS message having data of the image file and header information indicating that the message is an image message to the called mobile phone by the SMS.

2. The method of claim 1, further comprising the step of transmitting the image file in a plurality of successive SMS messages if the data amount of the image file exceeds the user data amount allowed for one SMS message.

3. A method of receiving information by a short message service (SMS) in a mobile phone having a memory for storing image files, comprising the steps of:
checking header information upon receipt of an SMS message;
performing a text message reception operation if the header information of the SMS message indicates a text message; and
storing image file data of the SMS message in the memory if the header information indicates an image message.

4. A method of transmitting information by a short message service (SMS) in a mobile phone having a memory for storing image files, comprising the steps of:
receiving information about a mobile phone to be called to which an image file selected by a user is to be transmitted;
transmitting an SMS message having data of the image file and header information indicating that the message is an image message to the called mobile phone by the SMS;
checking header information upon receipt of the SMS message;
performing a text message reception operation if the header information of the SMS message indicates a text message; and
storing image file data of the SMS message in the memory if the header information indicates an image message.

5. The method of claim 4, further comprising the step of transmitting the image file in a plurality of successive SMS messages if the data amount of the image file exceeds the user data amount allowed for one SMS message.
